(19) United States
(12) Patent Application Publication
(10) Pub. No.: US 2017/0226825 A1
(43) Pub. Date: Aug. 10, 2017

(54) SUBMERSIBLE PUMP SYSTEMS AND METHODS OF USE

(71) Applicant: SUBMERSIBLE PUMP PRODUCTION INNOVATIONS, LLC, HUNTINGTON BEACH, CA (US)

(72) Inventor: William K. Filippi, Huntington Beach, CA (US)

(73) Assignee: SUBMERSIBLE PUMP PRODUCTION INNOVATIONS, LLC

(21) Appl. No.: 15/019,664

(22) Filed: Feb. 9, 2016

(51) Int. Cl. E21B 37/00; E21B 19/22; E21B 17/20; E21B 37/02; E21B 37/08; E21B 41/00; E21B 47/04; E21B 27/00; E21B 34/08; E21B 34/10; E21B 17/05; E21B 43/12; B08B 9/043; B08B 9/045; E21B 34/06

(52) U.S. Cl. CPC E21B 37/00; E21B 34/063; E21B 19/22; E21B 17/20; E21B 37/02; E21B 37/08; E21B 41/0078; E21B 47/042; E21B 27/00; E21B 34/08; E21B 34/10; E21B 17/05; E21B 43/128; B08B 9/0433; B08B 9/0436; B08B 9/045; E21B 2034/002

(57) ABSTRACT

Systems, methods, and tools for economically performing downhole well maintenance, utilizing a flexible reinforced hose and maintenance tools designed to work with the hose. Tools include well perforation cleaning tools using water jets and/or brushes, pad removal tools, sand bailing tools, and fluid level meters.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Field of the Invention

The present apparatus relates to systems and tools for downhole well maintenance. More specifically, the systems, tools, and methods disclosed herein are for use in oil, gas, and water wells utilizing a hose and submersible pump, resulting in vastly reduced maintenance costs.

Description of the Related Art

When a well is not being produced, the fluid level in the well will rise due to the pressure in the well's production formation. The fluid level will continue to rise until the column of fluid in the well bore exerts a pressure on the formation equal to the formation pressure. At this point, fluid from the formation will stop flowing into the well and the fluid level will stop rising. This level is called the static fluid level. Once the well is put into production the fluid level in the well bore will begin to drop. As the fluid level drops, pressure on the formation is relieved and fluid from the formation will begin to flow into the well. If the fluid level continues to drop, more fluid will flow from the production zone at an increasing rate. If less fluid is pumped out of the well than the formation can produce, the fluid level will eventually stabilize at some point above the pump. At this point, fluid being pumped out of the well equals fluid flowing into the well. If more fluid than the production formation can produce is pumped out of the well, the fluid level will drop to the level of the pump's inlets and the pump will cavitate, eventually damaging production equipment. In this case, the pump is attempting to pump more fluid than the formation can produce. Maximum well production is achieved when all the fluid a well can produce is pumped to the surface. As such, in order to maximize well production (whether for oil, water, or gas) while simultaneously protecting production equipment, there is a need for mechanisms that will maintain the fluid level within a well to a position immediately above the pump's location in the well.

Maximum fluid production from a well is achieved when the fluid level is pulled down to the production formation and all pressure is removed from the formation. In an oil well, relieving this pressure not only maximizes the amount of fluid being produced but also increases the oil to water ratio since oil requires greater pressure relief than water to begin flowing through the formation. The most common way of producing an oil well is with a production string which consists of a pumping unit, tubing, rods, and a mechanical downhole pump. The pumping unit, located at the surface, is powered by an electric motor, pulleys, and drive belts. It produces an up and down motion which actuates the downhole pump through a series of steel rods which connect the pumping unit to the downhole pump. The rods run through the center of a string of steel tubing which also runs from the downhole pump to the surface of the well. The tubing provides a conduit for the production fluid to flow to the surface of the well. As the pumping unit strokes up and down, a plunger within the pump also strokes up and down. All the fluid, less leakage, that enters the pump is lifted to the surface. Each stroke of the pump sucks fluid into the pump and then lifts it to the surface. The amount of fluid being pumped is governed by pump size, stroke length of the pumping unit, and the number of strokes per minute. The fluid production can be slightly adjusted by changing the strokes per minute. All other variables would require considerable expense to change. The strokes per minute are adjusted by changing pulley and drive belts. This method of controlling production does not lend itself to fine adjustment of fluid flow.

A second and less common method of producing an oil well is with an electrically driven downhole pump. This is also the method used for producing the vast majority of water and gas wells. The downhole pump is connected to the bottom of a steel tubing string that reaches from the downhole pump to the surface of the well. An electric motor is connected to the bottom end of the pump. An electrical power cable extends from the surface to the pump motor and provides the power to run the motor. The motor drives the pump, which pumps fluid through the tubing to the surface of the well. This method of pumping gives a relatively constant flow rate which can be accurately adjusted with the use of flow control valves located at the surface. Flow control valves cannot be used with pumping units since they produce a given amount of fluid with each stroke regardless of valve opening.

Both methods of pumping run into problems if the fluid level in the well is pulled down to the level of the pump's inlets. This will happen if the pump produces more fluid than the well's formation can give up. In the case of mechanically driven pumps, the pump's intake chamber will not completely fill with fluid during each pumping unit stroke, resulting in air entering the chamber. This causes a pounding or jarring effect with each production stroke. The pump will continue to produce under this condition but, in time, the constant pounding will damage the pump, the production string, and the pumping unit. In the case of an electrically driven pump, the consequences are even more severe. Should the pump run dry, both the motor and the pump can be severely damaged in a very short time. If the pump runs dry, it will begin to heat up thereby damaging rings, seals, and the impellers within the pump, causing the pump to quickly fail. Furthermore, the motor on an electrically driven pump is located below the pump and needs a constant flow of fluid to cool the motor. If the pump fails, the cooling flows of fluid past the motor will stop and the motor will continue to run, overheat, and burn out within a short period of time.

As such, one would desire to pick a pump which produces the same amount of fluid as the well gives up. In the case of mechanically driven pumps, this simply cannot be done for several reasons. First, pumps do not come in an infinite range of production rates. Second, the use of pulleys, belts, and stroke length to adjust flow rates does not lend itself to the fine adjustments necessary to match the formation rate. In the case of electrically driven pumps, the production rates can be more easily controlled through the use of fine adjustment flow control valves. However, electrically driven pump rates are affected by a number of factors that do not affect mechanical pumps as severely. These factors also interact with each other and include, but are not limited to, frictional losses in the piping system, changes in downstream pressure in the production lines, pump and motor wear and loss of efficiency, changes in supplied voltage and amps, changes in the production fluid's viscosity, and changes in the amount of fluid a well can give up at any given time. Frictional losses, for example, are a function of rate of fluid flow. As the flow rate changes, the frictional losses change. This means that as one variable changes, it affects a second variable. Changes in downstream pressure can occur if there is a change in the production rate of a downstream well. The specific gravity and viscosity of the production fluid will change as the oil to water ratio changes during normal production. All of these factors interact and make fine adjusting of flow rates next to impossible.

Furthermore, and possibly most importantly, well formations do not produce fluid at either a constant flow rate or a constant viscosity. Formation flow rates can change from day to day or even hour to hour. In oil wells, the viscosity of the production fluid is also constantly changing as more or less oil is produced. This makes it impossible to size a pump to exactly match a well's ever changing formation flow. In order to overcome this problem and avoid damaging pumps and equipment, one has had to previously maintain the fluid level in wells well above the pump inlets or utilize timers to turn pumps on and off or other devices to control production rates. These methods, however, result in inefficient production, with a decrease in both total fluid production and oil to water ratio. Also, the starting and stopping of motors and pumps severely shortens their life span, since the life cycle of both electric motors and pumps is best when turned on and left to run constantly.

Solutions to these problems, namely, systems and methods of placing the downhole pump within or as close as feasible to the production formation while automatically adjusting the amount of fluid being produced from the well so as to pull the fluid level down to just above the pump's inlets and maintain it at this level have been previously described in U.S. Pat. Nos. 8,764,406 and 8,764,407, both titled Fluid Level Control Mechanism, and both of which are hereby incorporated by reference in their entirety.

While the use of a downhole pump with a fluid level control mechanism vastly increases production rates, and reduces operation costs, if standard production strings consisting of heavy steel tubing are still utilized, expensive pulling rigs are still necessary to install and pull wells. In that regard, a downhole submersible pump can utilize a lightweight flexible reinforced hose in place of a typical production string. By utilizing the flexible reinforced hose, the initial cost and installation of the production string can be vastly reduced and allows the operator, himself, to install and pull wells, thereby eliminating down time and the need for expensive pulling rigs. By using a flexible reinforced hose for the production string, installation and pulling costs are vastly reduced; however, downhole maintenance will still typically require an expensive production rig which is capable of the heavy lifting required for most maintenance work. The use of heavy prior art maintenance equipment, along with its need for a production rig, results in excessive down time and expense for the operator. One example of this is the scrubbing of downhole perforations with a wire brush. The brush, similar to a bottle brush, is attached to a string of heavy tubing. The weight of the tubing is required to overcome frictional forces and allows the brush to be lowered down into the well. Once the brush reaches the bottom of the perforations, it is raised. This procedure is repeated until the perforations have been brushed clean. To raise and lower several thousand pounds of tubing requires an expensive, powerful pulling rig. Using prior art techniques, this work cannot be done with a lightweight, flexible hose, requiring the well operator to call out a pulling rig and team to perform the maintenance.

Accordingly, there is a need for equipment and methods to allow for downhole maintenance without the use of heavy equipment and production rigs, and for equipment and methods that allow for the operator himself to conduct the maintenance, thereby minimizing the downtime and expense of performing downhole maintenance.

### BRIEF SUMMARY

One embodiment of the present disclosure is directed toward a system for performing downhole well maintenance, wherein the system includes a flexible reinforced hose and a downhole well perforation cleaning tool. The well perforation cleaning tool is configured to be attached to, and lowered by, the flexible reinforced hose. The well perforation cleaning tool has a pipe portion made up of a length disposed between a sealed cap at a distal end and an attachment portion at a proximal end, and further includes a plurality of cleaning devices disposed along the length of the pipe. The attachment portion is configured to be in fluid communication with the flexible hose. The cleaning devices may be water jets. The system may further include a reservoir disposed between the proximal end of the pipe and the flexible reinforced hose. In another embodiment of the cleaning tool, the cleaning devices may be retractable brushes.

In another embodiment, the perforation cleaning tool may further include a plurality of rotator jets disposed along the length of the pipe, such that the rotator jets are positioned parallel to a vertical axis of the pipe. This embodiment further includes a rotary swivel disposed between the tool and the flexible hose. This embodiment may further include at least one cleaning brush extending outwardly from the length of the pipe.

The system may include a reservoir tool. The reservoir tool includes a length of tube having a cavity disposed between a proximal opening on one end of the tube and a distal opening on the opposite end of the tube. The proximal and distal openings are configured to be attached to the flexible hose and other tools of the system.

Another component of the system may be a sand bailing tool. The sand bailing tool features an intake positioned below the reservoir tool and a float valve assembly positioned above the reservoir tool. In particular, the intake has a check valve disposed between an open-mouthed inlet portion and the reservoir tool. Furthermore, the inlet portion, check valve, and reservoir are all in fluid communication. The float valve assembly features a cylindrical valve assembly, an exit cap attached to the top portion of the valve assembly, a removable bottom cap attached to the bottom portion of the valve assembly, and a ball float disposed within the valve assembly. The valve assembly has openings at a top portion and a bottom portion and at least one fluid inlet disposed within its sidewall. The exit cap includes an exit opening surrounded by an embedded O-ring. The diameter of the ball float is less than the inner diameter of the valve assembly, but greater than the inner diameters of the O-ring and of the fluid inlet.

Another component of the system may be a pad removal tool. The pad removal tool includes a cylindrical intake tube having openings at distal and proximal ends, a bell-shaped inlet, and a check valve attached to the proximal end of the intake tube at one of its ends and to the reservoir at its other end. The bell-shaped inlet has a larger diameter opening at its distal end and a narrower diameter opening at its proximal end, and the inlet distal end is attached to the proximal end of the intake tube. The inlet further includes at least one vent hole disposed in the side of the inlet.

Another component of the system may be a burst valve having a valve body, nut, pressure seal, housing, and at least one shear pin. The valve body has a bottom portion at its distal end, disposed below a wider seat, and a threaded portion at its proximal end. The nut is threaded on to the threaded portion of the valve body. The pressure seal is located on the bottom portion of the valve body and abuts the valve body seat. The housing is configured to contain the assembled valve body such that the pressure seal rests on the bottom seat of the housing. The shear pins are inserted through shear pin holes in the housing into shear pin holes in the nut, such that the pressure seal maintains compression while the shear pins are in place.

Another component of the system may be a fluid level meter having an extended cylindrical body portion, a flashlight contained within the cylindrical body, a float, a compression spring, and graduated tape connected to the proximal end of the body portion. The flashlight is mounted along the same center axis as the body portion, and is located at a proximal end of the body portion such that the flashlight's bulb is directed upward toward the user, and the flashlight's momentary switch is directed downward. The float is located within, and slidably engaged with, a distal end of the body portion. The float is configured to engage the momentary switch when under pressure. The compression spring is connected to, and disposed below, the float.

Another component of the system may be a ballast tool. The ballast tool is configured to be attached to, and lowered by, the flexible reinforced hose. In particular, the hose is attached to the proximal end of a pipe running the length of the ballast tool. The distal end of the pipe may then be attached to a maintenance tool. The ballast tool further includes a tube with a larger diameter than the ballast tool pipe that extends around the ballast tool pipe along the same vertical axis. This creates a cavity between the tube and the ballast tool pipe, that is filled with a heavy weight material, such as cement.

Another embodiment of the present disclosure is directed toward a method of running and maintaining a well. The method includes the steps of attaching a submersible pump to a flexible reinforced hose, lowering the submersible pump down the well into the well fluid, operating the submersible pump, raising the submersible pump out of the well, attaching a well maintenance tool to the flexible reinforced hose, lowering the well maintenance tool down the well, and operating the well maintenance tool.

Under this method, the well maintenance tool may be a well perforation cleaning tool. In this embodiment, the well perforation cleaning tool is operated by filling the flexible hose with a cleaning fluid at an operating pressure sufficient to emit the fluid from the water jets and then raising and lowering the well perforation cleaning tool to clean the perforations as needed. Alternatively, the well maintenance tool may be a pad removal tool. In this embodiment, the pad removal tool is operated by lowering the pad removal tool until the check valve opens, thereby entrapping the pad in the reservoir, raising the pad removal tool out of the well, emptying the reservoir of the pad, and repeating as necessary to sufficiently remove the pad from the well.

Additionally, the well maintenance tool may be a sand bailing tool. In this embodiment, the sand bailing tool is operated by draining the flexible hose of fluid before attaching the sand bailing tool. The sand bailing tool is then pressurized using an inert gas before lowering it into the well. The sand bailing tool is then operated by continuing to lower it until it reaches the bottom of the well, at which point the pressure at the surface is relieved causing the check valve to open. Fluid and sand are, thus, vacuumed into the reservoir. Once fluid begins exiting the reservoir the float valve closes, thereby entrapping the sand in the reservoir. The sand bailing tool is then raised out of the well, the reservoir is emptied of sand, and the process is repeated as necessary to sufficiently remove sand from the well.

The method may further include lowering a fluid level meter into the well and accurately determining the current fluid level in the well.

Another embodiment of the present disclosure is directed toward a downhole well perforation cleaning tool configured to be attached to, and lowered by, a flexible hose. The cleaning tool includes a pipe portion made up of a length disposed between a sealed cap at a distal end of the pipe and an attachment portion at a proximal end of the pipe. The attachment portion is configured to be in fluid communication with the flexible hose. The tool further includes a plurality of cleaning devices disposed along the length of the pipe. The cleaning devices may be water jets, in which case the tool may further include a reservoir disposed between the proximal end of the pipe and the flexible hose. The tool may further include a plurality of rotator jets disposed along the length of the pipe and parallel to a vertical axis of the pipe, along with a rotary swivel disposed between the tool and the flexible hose. The tool may further include at least one cleaning brush extending outwardly from the length of the pipe.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a side plan view of a reservoir to be utilized with the disclosed system of tools;

FIG. 2A is a side plan view of the intake of a sand bailing tool;

FIG. 2B is a side plan view of an optional extension piece to be used with the sand bailing tool shown in FIG. 2A;

FIGS. 3A-3D are side plan views of a float valve and its internal components used with in conjunction with the sand bailing components illustrated in FIGS. 2A and 2B;

FIG. 4 is a side plan view of a pad removal tool;

FIG. 5A is a side plan view of a jet washing tool;

FIG. 5B is a top view of the jet washing tool shown in FIG. 5A;

FIG. 6A is a side plan view of a rotating jet washing tool with an optional scrubbing brush;

FIG. 6B is a top view of the rotating jet washing tool shown in FIG. 6A;

FIG. 7A is a side plan view of a rotary swivel used with the rotating jet washing tool shown in FIGS. 6A and 6B;

FIG. 7B is a partial cross-sectional view of certain components within the rotary swivel shown in FIG. 7A;

FIG. 8A is a side plan view of a retractable brush tool;

FIG. 8B is a top cross-sectional view of the retractable brush tool shown in FIG. 8A;

FIG. 9 is a side cross-sectional view of a ballast tool that may be utilized in conjunction with other tools described herein;

FIGS. 10A-10E are views of a burst valve, and its various internal components, that may be utilized in the system described herein; and

FIG. 11 is a side plan view of a fluid level meter that may be used with the system described herein.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

For many oil wells, replacing the typical production string of tubing, rod, and pumping jack with a flexible reinforced hose and a submersible pump will result in both considerable cost savings and increased production, due to several reasons. First, the initial cost and installation of the production string can be reduced by as much as seventy percent over that of a typical installation. Secondly, the lightweight flexible hose allows the operator, himself, to install and pull wells, thereby eliminating the downtime associated with scheduling a pulling rig. By eliminating the need for expensive pulling rigs, one can reduce pulling costs by as much as ninety percent or more. Furthermore, increased production can be achieved through the control and maximization of production rates. The use of submersible pumps allows production rates to be accurately controlled through the use of a fine adjustment flow control valve located at the surface. Production can be maximized through the use of Fluid Level Control Mechanisms (FLCMs) as described in U.S. Pat. Nos. 8,764,406 and 8,764,407. FLCMs are capable of holding the fluid level down to within four to five feet of the pump inlets, while preventing the pump from pumping off, thereby maximizing fluid production and increasing the fluid's oil to water ratio. Additionally, by substituting the use of a flexible reinforced hose in place of a common production string of tubing, rod, and pumping jack, an owner can install, operate, and pull wells himself without the need for expensive, and time consuming, pulling or production rigs. However, most downhole maintenance utilizing prior art tools and equipment will still require calling out a production rig. Accordingly, the present disclosure envisions and discusses new tools and equipment for downhole well maintenance that do not require a common pulling rig and can be performed by the well operator simply by using the same flexible reinforced hose as is used for production. These tools utilize the well's hydrostatic pressure, compressed gasses, and medium pressure fluid flow to perform various tasks, as will be described below in reference to the attached Figures, wherein reference numbers shown in the Figures and used in the specification reference the same part.

Reservoir:

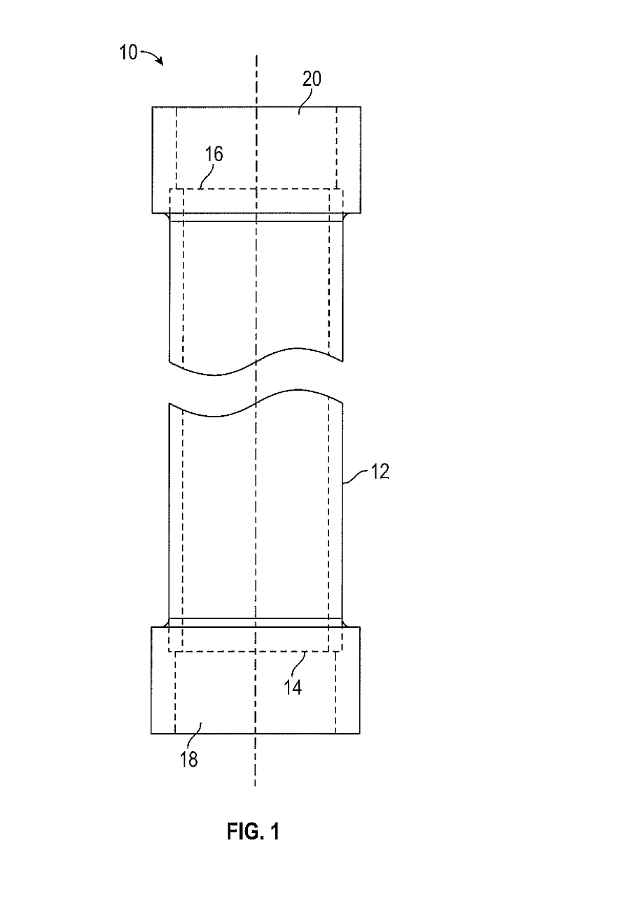

In particular, FIG. 1 shows a reservoir 10 that may be utilized with several of the tools described below. In particular, the reservoir 10 comprises a length of high-pressure tube 12 having a proximal opening 14 on one end and a distal opening 16 on the opposite end. In particular embodiments, the reservoir 10 is capable of containing sand and other debris when cleaning a well utilizing the tools described below, and the particular length of the tube 12 may be adjusted based upon the needs of the user. The reservoir 10 may include machined fittings 18, 20 attached to each opening 14, 16 of the tube 12 to allow for attaching the reservoir 10 to other components. In certain embodiments, the machined fittings 18, 20 may be welded to the tube 12. The tube 12 and fittings 18, 20 are constructed from materials capable of withstanding the high pressures to which they will be subjected when used in the well, including, for example, iron, steel, and the like. In certain embodiments, the tube 12 is constructed from 3-inch schedule 80 steel pipe. All of the components of the reservoir 10 should be able to withstand high pressures as required for a particular application.

Sand Bailer:

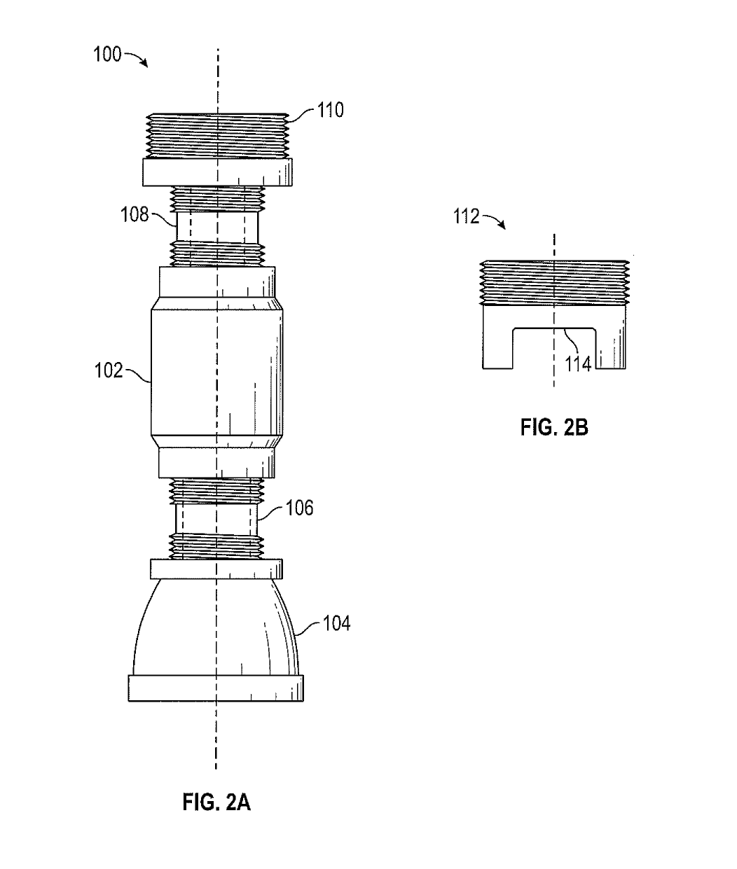

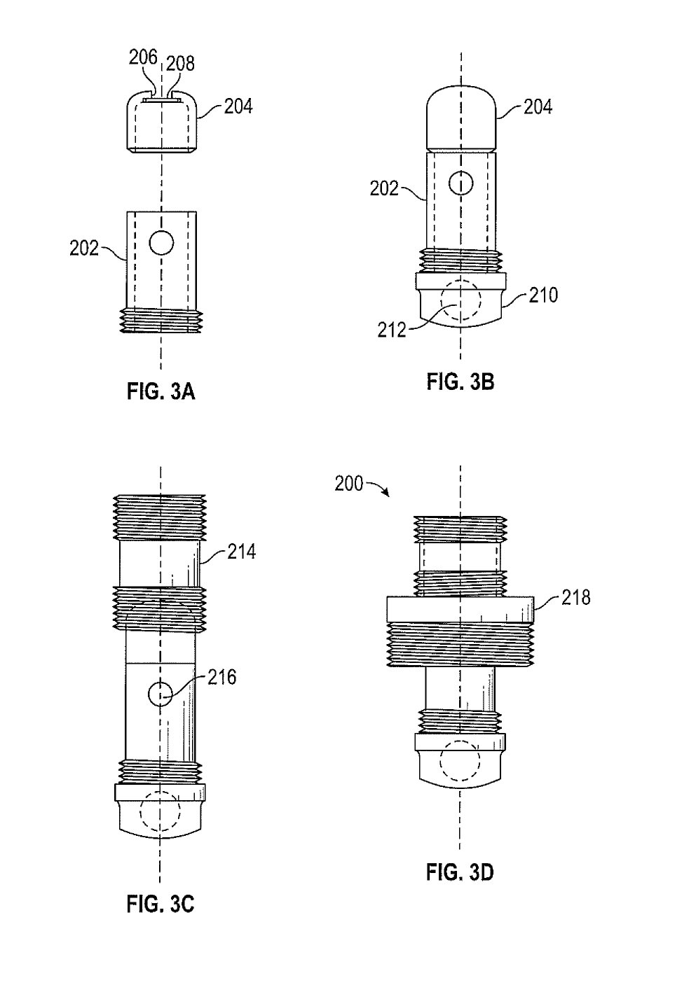

FIGS. 2A, 2B and 3A-D show the components of a sand bailer useful for cleaning the bottom of a well of any sand or other debris formed during production. The sand bailer comprises at least three separate components: the reservoir 10 as shown in FIG. 1 and described above, an intake 100 as shown in FIG. 2A, and a float valve assembly 200 as shown in FIGS. 3A-3D. In use, the reservoir 10 is positioned between the intake 100 and the float valve 200. In particular, the top of the intake 100 is attached to the bottom of the reservoir 10 and the bottom of the float valve 200 is attached to the top of the reservoir 10. The top of the float valve 200 is attached to the flexible hose (not shown) used with the system.

The intake 100 comprises a check valve 102 attached to, and in fluid communication with, an inlet portion 104. In particular, the inlet portion 104 is positioned below the check valve 102 to allow for fluid and sand within the well to be funneled first through the inlet 104, then through the check valve 102, and ultimately to the reservoir 10. The inlet 104 may be attached directly to the check valve 102, or may be connected via a lower connection piece 106. Although the inlet is typically bell-shaped, with the lower end of the inlet 104 wider than the check valve 102, the diameter and length may be determined and sized by well conditions and the inside diameter of the casing. Optionally, an inlet extension 112 (as shown in FIG. 2B) may be attached to the lower portion of the inlet 104 for specific well conditions where flow is desired from the sides of the inlet 104. This flow from the sides is realized by the inlet extension 112 having a plurality of horizontal openings 114 to allow for the horizontal ingress of fluid and sand via the horizontal openings 114 in addition to vertical ingress through the main opening of the inlet 104. The inlet extension 112 may also be closed at its bottom end to force fluid flow through the horizontal openings 114. In one embodiment, the extension 112 includes four horizontal openings 114. Alternatively, the inlet 104 itself may include horizontal openings 114. The check valve 102 is connected to the reservoir 10 by an attachment portion 110 located upstream of the check valve 102, either by being directly attached to the check valve 102 or by being fluidly connected via an upper connection piece 108.

FIGS. 3A-D illustrate the float valve 200 in detail. In particular, the float valve 200 comprises a cylindrical valve assembly 202 with an exit cap 204 attached to a top portion of the valve assembly 202. The exit cap 204 may be welded on to, or otherwise permanently attached to the valve assembly 202, or may be formed as a unitary unit with the valve assembly 202. The exit cap 204 may alternatively be removably attached to the valve assembly 202. The exit cap 204 includes an exit opening 206 which allows for gas and fluid flow through the exit cap 204. The exit opening 206 may further comprise an embedded O-ring 208 positioned around the opening 206. The float valve 200 further comprises a removable bottom cap 210 attached to a bottom portion of the valve assembly 202. Disposed within the valve assembly 202 is a ball float 212. The ball float 212 has a diameter less than the interior diameter of the valve assembly 202 to allow for the free movement of the ball float 212 within the valve assembly 202, but a diameter greater than the inside diameter of the O-ring 208, such that when fluid flows through the float valve 200 it pushes the ball float 212 up toward and ultimately against the O-ring 208, thereby forming a partial seal between the ball float 212 and the O-ring 208 and preventing fluid or sand from entering the hose once the reservoir 10 is filled. Further attached, either detachably or permanently, to the valve assembly, over the exit cap 204, is a threaded hose coupler 214, which allows for the flexible hose to be removably attached to the float valve 200. The valve assembly further comprises at least one fluid inlet 216 disposed within a sidewall of the valve assembly 202. The fluid inlet 216 has a diameter smaller than the ball float 212, to prevent the ball float 212 from escaping the float valve 200, but is still sufficiently sized to allow for the free flow of air trapped in the reservoir 10 and eventually fluid. In certain embodiments there may be two or more fluid inlets 216 present within the valve assembly 202. The float valve 200 further comprises a threaded reservoir coupler 218, which threads onto the base of threaded hose coupler 214 and allows for the float valve 200 to be removably inserted into and attached to the reservoir 10.

In order to use the sand bailer described above once a well has been pulled, all fluid must be drained from the hose. This can be achieved by running the hose back into the well with both hose ends open, and then pulling the hose back out of the well allowing the fluid to drain. Alternatively, this step can be skipped if a burst valve (described below) is used in the production string. Once the hose is drained, the sand bailer assembly is attached to the bottom of the hose via the hose coupler 214 of the float valve 200. Based on the fluid head, the hydrostatic pressure at the bottom of the well can be determined, the hose and the bailer are then pressurized, preferably using inert gas, to a pressure greater than the hydrostatic pressure. By thus pressurizing the bailer, the check valve 102 is prevented from prematurely opening due to hydrostatic pressure as it is lowered into the well. Once the bailer reaches the bottom of the well, and the inlet 104 is sitting on or near the well bottom, the pressure at the surface is relieved, thereby opening the check valve 102 and allowing fluid and sand to be vacuumed into the reservoir 10. Once the reservoir 10 is full, and fluid begins exiting the reservoir 10, the ball float 212 rises within the valve assembly 202 until ultimately seating against the O-ring 208 and forming a seal that prevents flow of the fluid into the hose. Once the flow has been stopped, the sand bailer is raised causing the check valve 102 to close, trapping fluid and sand in the reservoir 10. The bailer is then raised to the surface and emptied. This procedure may be repeated until the desired amount of sand has been removed from the well. If necessary, ballast can be added above the reservoir 10 to give the bailer sufficient weight to reach the bottom of the well.

Pad Removal Tool:

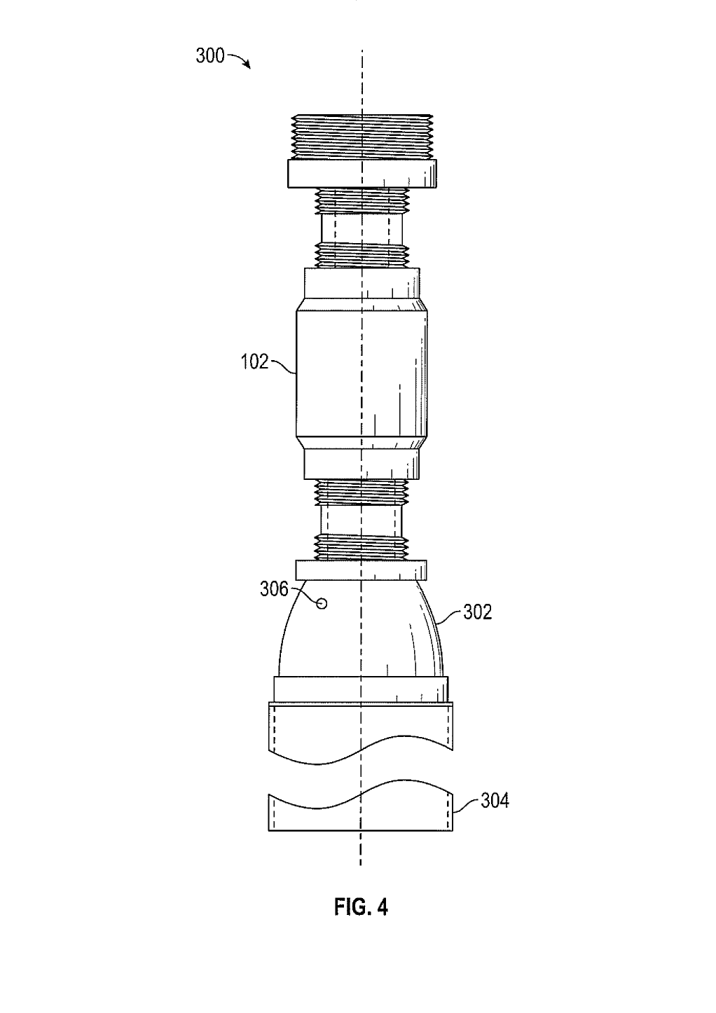

A primary concern with the use of submersible pumps in oil wells is that the oil pad, floating on the surface of the production fluid, will reach the pump's inlets causing the pump and/or motor to stall and burn out. A submersible pump's sizing is based on numerous parameters, one of which is the viscosity of the production fluid. In wells where the oil to water ratio is low, the oil pad may have a viscosity hundreds, or even thousands, of times greater than the production fluid. Therefore, if the pad reaches the pump's inlets, and is pulled into the pump, the sizing parameters for the pump will have dramatically changed. The pump will no longer be able to pump the heavy pad to the surface; however, the pump will attempt to continue running, eventually causing the pump or motor, or both, to burn out. Prior art devices protect against this by turning the motor off when the fluid level approaches the pump inlets and then restarting the motor after a certain period of time has passed, thus allowing the fluid and the pad in the well to rise away from the pump. However, this is an incomplete fix as it only delays the inevitable rather than preventing it. By turning the motor on and off in this fashion, not only is production efficiency reduced (there are now portions of time where the pump is not producing), but the pad continues to grow at an even greater rate since no oil is being removed while fluid is still flowing into the well when the motor is not running, resulting in continually shorter run times. Also, turning the motor on and off reduces the life cycle of the pump and motor. As such, there is a need in the art to actually remove the pad completely instead. Such a tool would ideally be used every time a motor starts cycling due to an oil pad and every time a well is pulled for any reason. FIG. 4 shows such a pad removal tool 300 as envisioned by the present disclosure. The pad removal tool 300 is similar to, and operates on the same concepts as, the sand bailer described above in that it uses the same check valve 102 and the same reservoir 10. The pad removal tool 300 differs from the sand bailer, however, in that the intake 302 is different, it does not require the use of a float valve 200, and the system need not be pressurized and depends only on hydrostatic pressure to operate. Similar to the sand bailer, ballast may be utilized when necessary with the pad removal tool 300.

Since the pad removal tool 300 does not need to be pressurized, it may be constructed from low pressure components. In particular, the pad removal tool 300 comprises an intake tube 304, attached to a removable inlet 302, disposed below the check valve 102, which is likewise positioned below, and detachably connected to the reservoir 10 above it, which is ultimately connected to the flexible hose used throughout the system as disclosed herein. The length of the intake tube 304 is determined by the pressure differential required to open the check valve 102. In certain embodiments of the present disclosure, a check valve 102 having a pressure differential of 0.5 psi is utilized. When a 0.5 psi check valve 102 is utilized, it will only open when it is approximately 1.15 feet below the surface. In order to capture this upper portion of the pad, the intake tube 304 must reach at least 1.15 feet below the check valve 102. As such, in certain embodiments the intake tube 304 may be about two feet long in order to provide a sufficient margin. The intake 302, is detachably connected to the check valve 102 and may include at least one vent hole 306 in an upper region of the intake 302. As the pad removal tool 300 is lowered into the pad, the check valve 102 remains closed and the pad enters the intake tube 304. As the pad removal tool 300 is being lowered into the pad, air trapped in the intake tube 304 escapes out the plurality of vent holes 306, thereby allowing the pad to enter the tube 304 and displace the air contained within the tube 304. The vent holes 306 are sized so that air may escape, but are small enough to prevent the heavy pad from passing through them at the low working pressures. As the pad removal tool 300 continues to be lowered, the check valve 102 will eventually open allowing the pad trapped in the intake 302 and the intake tube 304, along with additional pad or fluid, to flow up through the intake tube 304, through the check valve 102, and ultimately in to the reservoir 10. By knowing the static fluid level, and the total length of the reservoir 10 and pad removal tool 300 combined, the user can determine how far to lower the pad removal tool 300 into the well to ensure the reservoir 10 is filled as much as possible. Once the reservoir 10 has been lowered to the correct depth, the pad removal tool 300 is pulled from the well, whereby the check valve 102 closes, trapping the pad in the reservoir 10. This procedure may be repeated numerous times until the desired amount of pad is removed from the well. As can be readily understood, a float valve is not needed for the pad removal tool 300 as the user knows in advance the depth it needs to be lowered in the well, pressure and flow rates are extremely low, and because it is not disadvantageous if some pad enters the flexible hose.

Cleaning Perforations:

Cleaning perforations in the well is normally done whenever a well is pulled. In the past, the perforations have been cleaned by scrubbing with a wire brush, jet washing, or the use of chemical baths. The present disclosure envisions several types of perforation cleaning tools that are capable of being used with the flexible hose system described herein.

Jet Washing Tool:

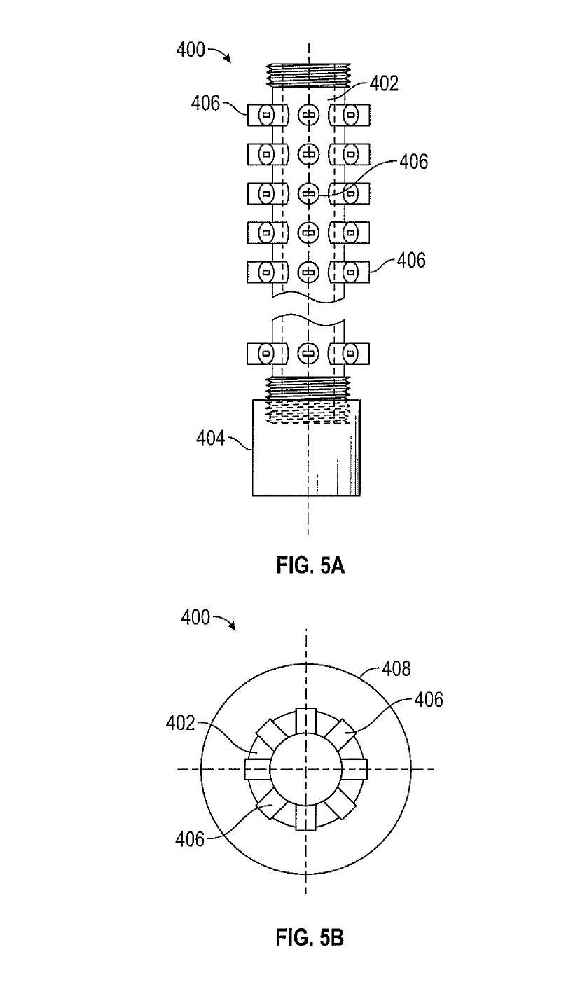

FIGS. 5A and 5B illustrate a downhole jet washing tool 400 that may be used to clean perforations. The jet washing tool 400 comprises a length of high pressure pipe 402 that is sealed at its bottom with a sealing cap 404. The sealing cap 404 may be permanently affixed to the pipe 402, detachably attached, or formed directly within the pipe 402. The pipe 402 includes a plurality of water jets 406 disposed along its length. The jets 406 are disposed normal to the pipe 402 facing in an outward direction. The jets 406 may be configured to produce a flat horizontal angular spray of water. The jets 406 are optimally located along the pipe 402 such that as you move vertically up the pipe 402, each jet's angular spray overlaps its adjacent jet's spray, thereby ensuring total coverage of the inside surface of the well's casing 408. As such, the angular spacing and minimum number of jets 406 can be determined for complete coverage based on the diameter of the well's casing 408. However, the number of nozzles must be an even number in order to keep the jet washing tool 400 centered, at best, within the casing 408, since each jet 406 produces thrust that needs to be counterbalanced by an opposing jet 406. In one example, an eight jet 406 configuration is utilized, with each jet 406 having a 120 degree spray angle. In a casing 408 having an inner diameter of 4.7 inches, the angular spacing between jets 406 is 45 degrees. The number of jets 406 utilized in the tool 400, the jets' orifice size, and desired working pressure all will determine the required fluid flow for the tool 400 to operate properly.

When using the jet washing tool 400, the flexible hose does not need to be drained first, since fluid, not gas, is the working medium. The process of utilizing the jet washing tool 400 comprises attaching the top portion of the jet washing tool 400 to the bottom of the reservoir 10. The reservoir 10 adds fluid volume and acts like a plenum chamber, the reservoir 10 is then attached to the flexible hose, optionally with a ballast (if necessary) disposed between the reservoir 10 and the hose. The jet washing tool 400 is then lowered in to the well such that it is situated near the perforations to be cleaned. The hose is then filled with a suitable fluid, for example, from adjacent wells or from an outside source. Examples of fluids that may be used to clean perforations include, but are not limited to, fresh water, hot water, a cleaning solution, well fluid itself, combinations thereof, and the like. Once filled to the static fluid level, and as more fluid is added, the jets 406 will begin to emit the fluid being utilized, and additional fluid must be pumped into the hose until the hose fills and the desired working pressure is reached. The working pressure is generally chosen to be high enough to clean the perforations, but low enough to not damage the casing 408. When the jet washing tool 400 has reached the desired working pressure, the tool 400 may be raised and lowered, thereby cleaning the perforations by the directed, pressurized, emission of the fluid. If it is desired to use fluid from the well itself as the operating fluid for the tool 400, a submersible pump may be located in the well immediately above and connected to the tool 400 to introduce a steady flow of well fluid into the tool 400 during operation. In this case, the hose is being used only as a cable and not as a conduit for fluid.

Rotating Jet Washing Tool:

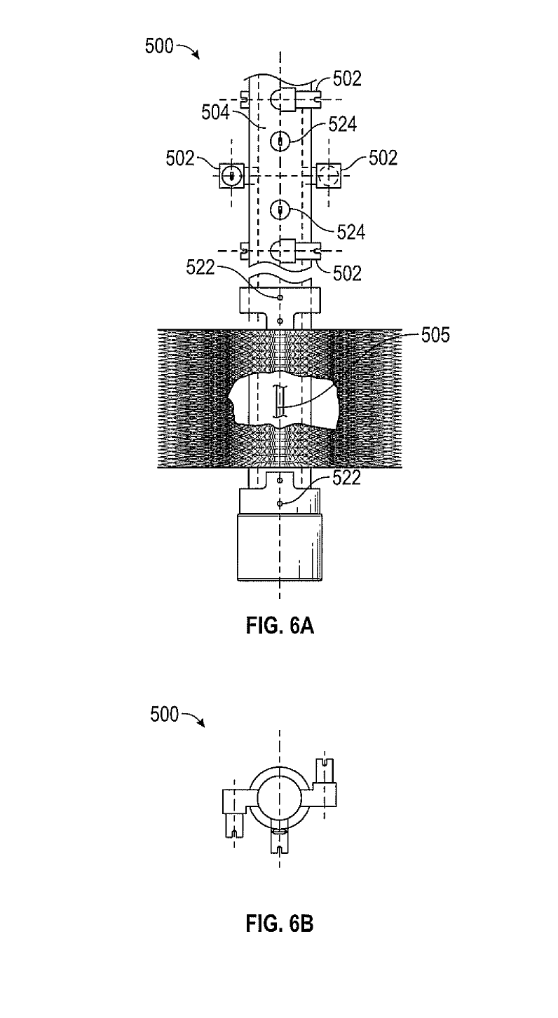

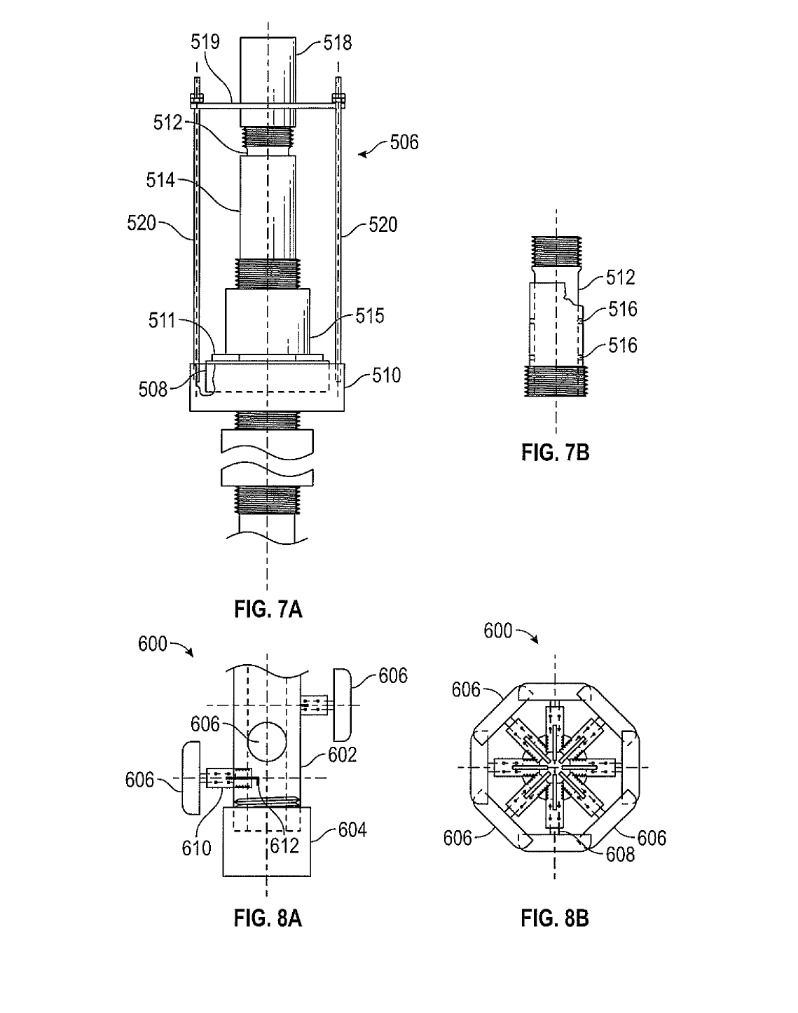

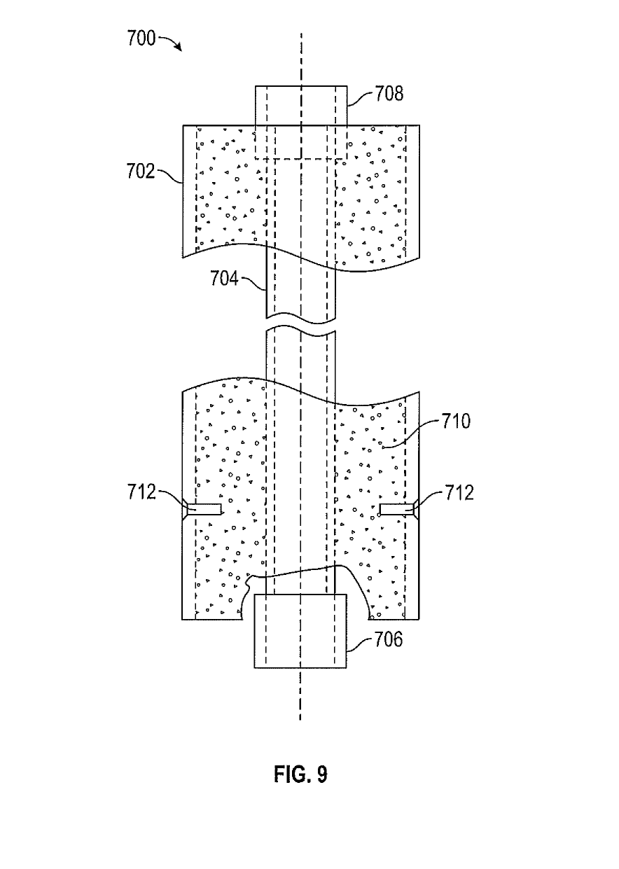

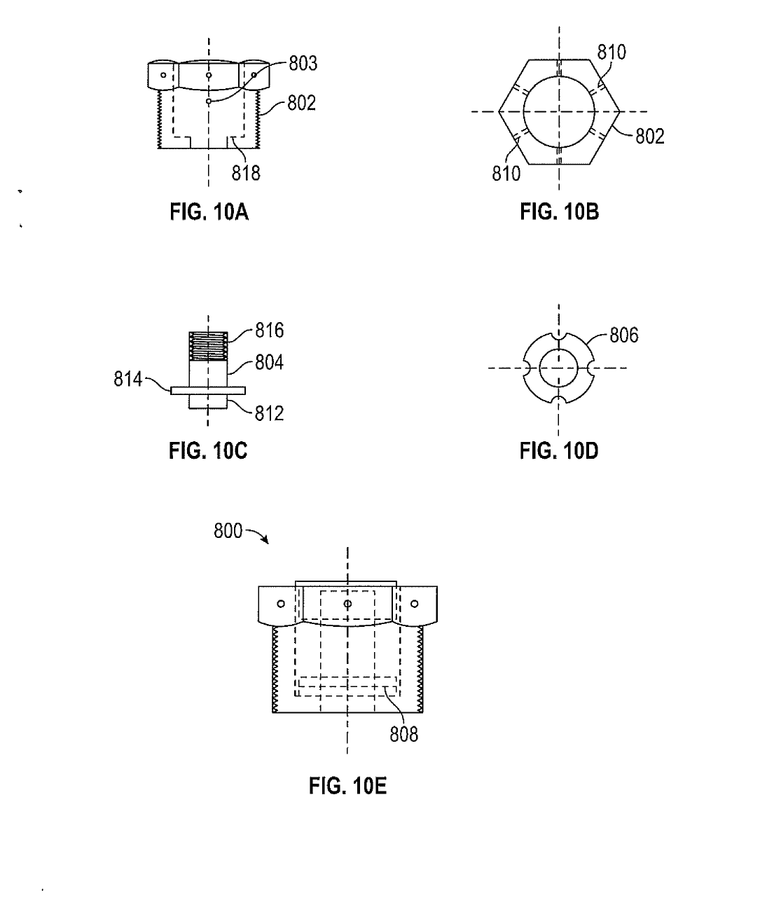

A rotating variation 500 of the jet washing tool is illustrated in FIGS. 6A, 6B, 7A, and 7B. This version may include a rotating brush 522 to scrub the perforation while the jets both clean perforations and provide the torque to rotate the tool 500. The brushes 522, if used, may be locked in place by upper and lower clamps, which help prevent the brushes 522, while in contact with the casing 408, from slipping while the tool 500 spins. The clamps themselves may be locked in place by set screws which fit into a groove 505 in the pipe 504. The rotating jet washing tool 500 is substantially similar to the standard jet washing tool 400, with the main differences being the optional addition of a plurality of brushes 522 and that the plurality of jets 502 are now positioned so that the direction of the angular spray is parallel to the vertical axis of the pipe 504. The jets 502 are disposed such that they all create thrust in the same direction, either clockwise or counterclockwise around the pipe 504. The combined thrust of the rotator jets 502 will create a torque causing the rotating jet washing tool 500 to spin. Additionally, the rotator jets 502 may be positioned such that the angular spray produced is flat and vertical, as opposed to the flat and horizontal spray produced by the jets 406 in the standard jet washing tool 400. In order for the tool 500 to properly rotate, it requires the use of a rotary swivel 506, thrust bearing 508, and thrust bearing housing 510 disposed at the top of the tool 500, all of which are illustrated in FIG. 7A. As one can readily understand, the rotary swivel 506 shown in FIG. 7A is located above, and connected to, the remainder of the rotating tool 500 shown in FIG. 6A. The rotary swivel 506 comprises an inner tube 512 disposed within an outer housing 514. As can best be seen in FIG. 7B (a partial phantom view of 7A), seated between the inner tube 512 and the outer housing 514 is at least one O-ring 516, which seals the inner tube 512 and outer housing 514 together, while allowing the outer housing 514 to spin. The inner tube 512 is further connected to a hose adaptor 518 that ultimately connects to the flexible hose, whereas the outer housing 514 is further connected to a couple 515 welded to a washer 511. Attached to the hose adapter 518 is a fixed mounting plate 519 that supports tension rods 520 ultimately connecting, and retaining in position, the hose adapter 518 and the housing 510. The thrust bearing housing 510 is configured to contain the thrust bearing 508, and to take the axial load of the rotary swivel 506, wherein the washer 511 is seated upon the bearing 508. In order to keep the entire unit unitary, the hose adaptor 518 and the thrust bearing housing 510 are connected by a plurality of tension rods 520 that run parallel with the rotary swivel 506.

In use, the rotating jet washing tool 500 utilizes an operating pressure of fluid designed not to damage the casing 408. Beyond that, the amount of fluid flow required to spin the rotating jet washing tool 500 is determined by the number of jets 502, the jets' orifice size, and the required torque to spin the tool 500. The number of jets 502 located on the tool 500 is primarily determined by the needed torque to rotate the tool 500. Functionally, the rotating jet washing tool 500 is operated substantially similar to the standard jet washing tool 400, that is, it is raised and lowered within the well casing 408 while pressurized fluid is forced through the rotating jets 502, thereby cleaning the surrounding perforations.

Optionally, the rotating jet washing tool 500 may further include at least one brush 522 disposed within the exterior of the tool 500 and extending outward to scrub the perforation. In this embodiment, additional force jets 524, configured perpendicular to the pipe 504 and pointing directly outward are required, in order to create thrust and push and hold the brushes 522 against the wall of the casing 408 as the tool 500 rotates. In order for the rotating tool 500 with brushes 522 to fit down into the casing 408, the total diameter of the device 500, including the extending brushes 522, must be less than the inner diameter of the casing 408. Simply spinning the tool 500 will not guarantee that the brushes 522 will contact the all sides of the casing 408. As such, the force jets 524 are utilized in addition to the rotating jets 502, in order to push the brushes 522 up against the casing 408 and ensure full coverage during the cleaning process. When operating the tool 500 containing the optional brushes 522, the tool 500 must be lowered to the bottom of the perforations before being run, and only then can the tool 500 be pressurized with fluid, at which point the tool 500 may be raised, thereby cleaning the perforations with both jet washing and wire brush scrubbing. Fluid flow to the tool 500 is then ceased, at which point the tool 500 can be lowered again and the process repeated as many times as is necessary. Since the brushes 522 may rub up against the casing 408 while being lowered, it may be necessary to utilize ballast with this embodiment.

Retractable Brush Tool:

In the past, most perforations have been cleaned by simply running wire brushes up and down the inside of the well casing. A traditional pulling rig using several thousand pounds of tubing weight is able to easily overcome the frictional forces required to lower the wire brush down into the casing. The traditional pulling rig also has enough power to lift the massive weight and overcome the frictional forces in doing so. In contrast, when using the improved flexible hose system as described herein, there is enough tensile strength in the hose and fittings to overcome the frictional forces when lifting a brush; however, there is not sufficient weight to force a brush down, even with the use of a significant amount of ballast. One solution to this problem is to retract the brushes during the down movement, to minimize friction between the brushes and the casing such that the tool is capable of descending, and then fully extend the brushes before pulling back up the casing. An example of one such embodiment is shown in FIGS. 8A and 8B, wherein a retractable wire brush tool 600 comprises a high pressure pipe 602 which has a sealed cap 604 at its lower, distal end, and a plurality of brushes 606 located vertically along the length of the pipe 602. These brushes 606 extend outward from the pipe 602 and are configured to retract back against the pipe 602 during the tool's descent into the casing, and to extend outward from the pipe 602 when in use before raising the tool 600, such that the brushes 606 are in contact with the casing 408. The number of brushes 606 may be varied, and are selected to ensure overlap to provide a complete interface with the inside of the casing 408. The brushes 606 may be disposed along the length of the pipe 602 such that they are staggered in orientation along the length of the pipe 602, such that an individual brush 606 is not directly abutting another brush 606, or they may be disposed radially around the pipe 602 such that when extended each brush 606 directly abuts its two surrounding brushes to provide complete coverage. In one embodiment, each brush 606 has a shank 608 that is inserted within a brush housing 610. There is at least one O-ring disposed between the shank 608 and the housing 610 to complete a seal between the two parts, while allowing for ready movement. A retaining pin 612 may be utilized to keep the brushes 606 locked into the housing 610, wherein the pin 612 is inserted through the back of the housing 610 and into the shank 608, such that the shank 608 may move freely within the housing 610, but prevents the brush 606 from slipping completely out of the housing 610. The housings 610 are then screwed into the pipe completing the assembly of the tool 600. The tool 600 is then filled with a fluid such as oil to minimize pressure leakage through the brush housing 610 when the tool 600 is pressurized. Ballast is attached to the top of the wire brush tool 600, which is then connected to the drained flexible hose used throughout. In order to operate the tool 600, the brushes 606 are pushed into the pipe 602, such that there is sufficient clearance for the tool 600 to be easily lowered into the casing 408. Once the tool 600 enters the well's fluid, the hydrostatic pressure will keep the individual brushes 606 pushed into the pipe 602. When the tool 600 reaches the bottom of the perforations to be cleaned, the pipe 602 is pressurized forcing the brushes 606 outward against the casing 408. The tool 600 is then raised to scrub the perforations. Once the top of the perforations is reached, enough pressure can be reduced to allow hydrostatic pressure to force the brushes 606 back within the pipe 602, to a point where enough friction has been relieved to allow the tool 600 to be lowered again and repressurized to continue cleaning the casing 408. This can be repeated as many times as is necessary to fully clean the perforations.

Ballast Tool:

As discussed throughout above, in certain situations additional ballast may be necessary for the tools to properly operate. As such, the present disclosure envisions a ballast tool 700 that may be used with any of the tools described herein when necessary. The ballast tool 700 comprises a large diameter tube 702 with a high pressure pipe 704 running through the middle of the tube 702 along the same vertical axis. Both the distal end 706 and the proximal end 708 extend beyond the length of the larger tube 702 and are configured to attach to the above-described tools at the distal end 706 and to the flexible hose used with this system at the proximal end 708. The cavity 710 formed between the pipe 704 and the outer tube 702 is filled with cement or other heavy weight material. Inserts 712, such as screws or the like, are inserted through the outer tube 702 into the cavity 710 in order to keep the outer tube 702 from separating from the filling material inserted into the cavity 710. The length of the tool 700 may be adjusted accordingly to provide the necessary amount of ballast for the current use.

Miniature Burst Valve:

A further tool envisioned by the present disclosure is a miniature burst valve 800 capable of being installed within the production string of the system described herein. The burst valve 800 serves two main functions, first, the valve 800 may be used to protect the flexible hose and tools from over pressurization. Second, the valve 800 may be used as a drain plug when pulling a well. By draining the fluid from the hose before pulling the well, it results in less weight to be pulled and less mess at the surface as the hose is wound on a spool. The valve 800 comprises a housing 802 (which is capable of screwing into the bottom of a production string), valve body 804, nut 806, a pressure seal 808, and at least one shear pin. The nut 806 has grooves along its periphery to allow fluid drainage. The method of loading the valve 800 follows a few simple steps that the operator himself can perform. First, the diameter of the shear pin(s) that is required is determined. In that regard, the housing 802 includes a plurality of shear pin holes 810 disposed within an upper portion. The shear pin holes 810 have different diameters, to accommodate various shear pin sizes, ultimately resulting in different shear loads depending on which shear pin(s) is used. The shear pin size is then matched to the correct hole 810 in the housing 802. The valve body has a bottom portion 812 disposed below a wider seat 814 (which also has grooves similar to the nut 806 for fluid drainage) and a threaded portion 816 at its upper end. The pressure seal 808 is slipped on to the bottom 812 of the valve body 804 and up against the seat 814. The valve nut 806 is then screwed on to the threaded portion 816 of the valve body 804, flat side up. This assembled valve body 804 is then inserted into the housing 802 such that the seal 808 rests on a bottom seat 818 of the housing 802, without applying any downward pressure. The nut 806 is held in place while the valve body 804 is turned (for example, by way of a screwdriver slot at its upper end) until the nut extends above the housing 802. In a preferred embodiment, the nut 806 extends approximately 0.020 inches above the housing 802. This distance can be measured using a feeler gage or other appropriate tool. This proper distance should be realized without any downward pressure being applied to the body 804. At this point, the housing 802 may be secured, such as within a vice, and the seal 808 is compressed until the top of the nut 806 is flush with the housing. Based upon the selected shear pin diameter, a hole is drilled through the appropriate shear pin hole 810 in the housing 802 in to the nut 806. In a preferred embodiment, the hole is drilled approximately 0.15 inches in to the nut 806. The shear pin is then inserted into the drilled hole, thereby appropriately compressing the seal 808 and loading the burst valve 800. Optionally, an additional retainer pin may be inserted through a hole 803 in the valve housing 802 into the cavity in the housing 802 between the seat 814 and nut 806, such that once the shear pin shears, the body 804 remains retained within the housing 802 by the retainer pin. When the burst valve is placed in the production string, it will prevent overpressurization of the hose or tools, by shearing and releasing the pressure once the desired limit pressure is reached. Additionally, when pulling the production string, one may intentionally burst the valve by pressurizing the system with inert gas. By doing so, hydrostatic pressure will drive the body 804 back away from the housing seat 818 allowing the production fluid to drain as the well is pulled.

Fluid Level Meter:

Submersible pump systems have a major advantage over traditional rod pumps in that simply opening or closing a flow control valve at the surface can precisely control the well's fluid production and fluid level, even during production of the well. In contrast, a rod pump's production rate can only be changed in large increments and when the pump is not in production, by changing belts and pulleys on the pumping jack. This results in inefficiencies during production, and time consuming shut downs and substantial cost each time rates have to be changed.

However, as a pump's production rate changes, the fluid level in a well will either move up or down. That is, the fluid level above the pump will decrease as the production rate increases (more fluid is pulled from the well than is being produced). Conversely the fluid level will increase as the production rate decreases. Maximum fluid and oil production is achieved when the hydrostatic head is reduced as much as possible. This is done by placing the pump in or as close as possible to the production zone and pulling the flow level down to just above the pump's inlets and holding it there. The danger with this method is if the fluid level is overly decreased such that the pump cavitates, thereby causing damage to the production equipment. One way of overcoming this problem is to use an accurate fluid level meter 900 to determine the fluid level while in production. The fluid level meter 900 also has numerous other uses during well maintenance. For example, when using the sand bailing tool described above, a static fluid level is required to determine the hydrostatic pressure at the bottom of the well. This information can be used to calculate the pressure required to keep the check valve closed. Additionally, the static fluid level can be determined when using the pad removal tool 300, so that the user knows how far to lower the pad removal tool 300 before retrieving it. Further, when scrubbing perforations, the static fluid level is used to determine the amount of pressure required to extend brushes or develop thrust for water jets. Also, pressures are used to determine shear pin diameters for the burst valve 800 described above. As such, it can be seen that there are numerous reasons why knowing the exact fluid level to within a foot or less can be critically important during the production or maintenance of a well.

At present, sound meters are commonly used to determine fluid levels and are not very accurate, as they can be off by twenty feet or more. These meters are based on the speed of sound through a medium, namely, air. The problem with this is that sound travels through air at 1086 feet per second, through CO₂ at 913 feet per second, and through methane at 1521 feet per second. In a given well, all three gases may be present in varying and changing quantities. In order to be accurate, sound meters have to be constantly calibrated, which requires knowing the exact depth of the fluid level.

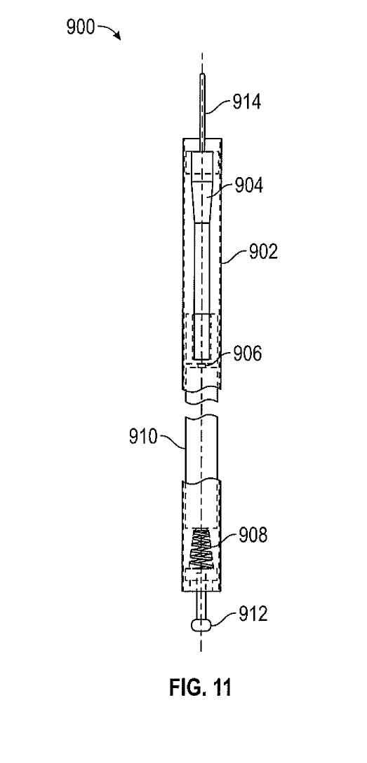

The present disclosure envisions a tool 900, having an accuracy of one foot or less, as illustrated in FIG. 11. More particularly, the fluid level meter 900 comprises an extended cylindrical section 902 configured to contain a standard intrinsically safe flashlight 904 along its center axis such that when the fluid level meter 900 is lowered into a well the bulb of the flashlight 904 points upward toward the user. A momentary (or magnetic) switch 906 of the flashlight 902 is connected to a compression spring 908 by way of a float 910 that is slidably engaged within the cylinder 902. The portion of the cylinder 902 encompassing the float 910 may be perforated to allow easy fluid access to the float 910. In use, when the meter 900 is lowered within the well by a graduated tape (not shown) and reaches the well fluid, the float 910 rises, thereby closing the switch 906 and turning on the flashlight 904. The user looking down the well can visually observe the light being emitted by the flashlight 904 and know where the fluid level precisely is. The meter 900 can be used on its own to simply determine the static fluid level in preparation for well maintenance, or can be used jointly with a submersible pump such that while the well is being produced, and the fluid level being adjusted by means of the flow control valve, the user can visually determine the exact fluid level The compression spring 908 is configured such that it provides a fine adjustment between the float 910 and the switch 906, through the use of a thumb screw 912 attached to the spring 908 and extending through the bottom of the meter 900. A locking mechanism 914 is utilized at the top of the meter 900 in order to secure the flashlight 904 in place as the float 910 rises and is also the attaching point for the calibrated tape (not shown).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for performing downhole well maintenance comprising:
a flexible reinforced hose;
a downhole well perforation cleaning tool configured to be attached to, and lowered by, the flexible reinforced hose, said well perforation cleaning tool comprising:
a pipe portion comprising a length disposed between a sealed cap at a distal end of the pipe and an attachment portion at a proximal end of the pipe, wherein the attachment portion is configured to be in fluid communication with the flexible hose;
a plurality of cleaning devices disposed along the length of the pipe.

2. The system of claim 1, wherein the plurality of cleaning devices comprise water jets, and wherein the system further comprises a reservoir disposed between the proximal end of the pipe and the flexible reinforced hose.

3. The system of claim 2, further comprising a plurality of rotator jets disposed along the length of the pipe positioned parallel to a vertical axis of the pipe and a rotary swivel disposed between the tool and the flexible hose.

4. The system of claim 3, further comprising at least one cleaning brush extending outwardly from the length of the pipe.

5. The system of claim 1, wherein the plurality of cleaning devices comprise retractable brushes.

6. The system of claim 1, further comprising a reservoir tool, said reservoir tool comprising a length of tube having a cavity disposed between a proximal opening on one end of the tube and a distal opening on the opposite end of the tube, wherein the proximal and distal openings are configured to be attached to the flexible hose and other tools of the system.

7. The system of claim 6, further comprising a sand bailing tool, said sand bailing tool comprising an intake positioned below the reservoir tool and a float valve assembly positioned above the reservoir tool, wherein:
the intake comprises a check valve disposed between an open-mouthed inlet portion and the reservoir tool, wherein the inlet portion, check valve, and reservoir are all in fluid communication;
the float valve assembly comprises:
a cylindrical valve assembly having openings at a top portion and a bottom portion and at least one fluid inlet disposed within a sidewall of the valve assembly;
an exit cap attached to the top portion of the valve assembly, wherein the exit cap includes an exit opening surrounded by an embedded O-ring;
a removable bottom cap attached to the bottom portion of the valve assembly; and
a ball float disposed within the valve assembly, wherein the diameter of the ball float is less than an inner diameter of the valve assembly but greater than an inner diameter of the O-ring and of the fluid inlet.

8. The system of claim 6, further comprising a pad removal tool, said pad removal tool comprising:
a cylindrical intake tube having openings at distal and proximal ends;
a bell-shaped inlet having a larger diameter opening at its distal end and a narrower diameter opening at its proximal end, wherein the inlet distal end is attached to the proximal end of the intake tube;
at least one vent hole disposed in a side of the inlet; and
a check valve attached to the proximal end of the intake tube at one of its ends and to the reservoir at its other end.

9. The system of claim 1, further comprising a burst valve, said burst valve comprising:
a valve body comprising a bottom portion at its distal end, disposed below a wider seat, and a threaded portion at its proximal end;
a nut, disposed on the threaded portion of the valve body;
a pressure seal disposed on the bottom portion of the valve body and abutting the valve body seat;
a housing configured to contain the assembled valve body such that the pressure seal rests on a bottom seat of the housing; and
at least one shear pin, inserted through a shear pin hole in the housing in to a shear pin hole in the nut, such that the pressure seal maintains compression.

10. The system of claim 1, further comprising a fluid level meter, said meter comprising:
an extended cylindrical body portion;
a flashlight contained within the cylindrical body portion along the same center axis, and disposed at a proximal end of the body portion such that a bulb of the flashlight is directed upward and a momentary switch of the flashlight is directed downward;
a float disposed within, and slidably engaged with, a distal end of the body portion, wherein the float is configured to engage the momentary switch when under pressure;
a compression spring connected to, and disposed below, the float; and
a graduated tape connected to the proximal end of the body portion.

11. The system of claim 1, further comprising a ballast tool configured to be attached to, and lowered by, the flexible reinforced hose at a proximal end of a ballast tool pipe running the length of the ballast tool, and to be attached to a maintenance tool at a distal end of the ballast tool, wherein the ballast tool comprises a tube with a larger diameter than the ballast tool pipe and extends around the ballast tool pipe along the same vertical axis, thereby creating a cavity between the tube and the ballast tool pipe, wherein the cavity is filled with a heavy weight material.

12. A method of running and maintaining a well comprising:
a) attaching a submersible pump to a flexible reinforced hose;
b) lowering the submersible pump down the well into the well fluid;
c) operating the submersible pump;
d) raising the submersible pump out of the well;
e) attaching a well maintenance tool to the flexible reinforced hose;
f) lowering the well maintenance tool down the well; and
g) operating the well maintenance tool.

13. The method of claim 12, wherein the well maintenance tool is a well perforation cleaning tool comprising a pipe portion comprising a length disposed between a sealed cap at a distal end of the pipe and an attachment portion at a proximal end of the pipe, wherein the attachment portion is attached to a reservoir, both of which are in fluid communication with the flexible hose, and a plurality of water jets disposed along the length of the pipe, and wherein the well perforation cleaning tool is operated in step (g) by filling the flexible hose with a cleaning fluid at an operating pressure sufficient to emit the fluid from the water jets and raising and lowering the well perforation cleaning tool to clean the perforations.

14. The method of claim 12, wherein the well maintenance tool is a pad removal tool comprising a cylindrical intake tube having openings at distal and proximal ends; a bell-shaped inlet having a larger diameter opening at its distal end and a narrower diameter opening at its proximal end, wherein the inlet distal end is attached to the proximal end of the intake tube; at least one vent hole disposed in a side of the inlet; and a check valve attached to the proximal end of the intake tube at one of its ends and to the reservoir at its other end; and wherein the pad removal tool is operated in step (g) by lowering the pad removal tool until the check valve opens, thereby entrapping the pad in the reservoir, raising the pad removal tool out of the well, emptying the reservoir of the pad, and repeating as necessary to sufficiently remove the pad from the well.

15. The method of claim 12, wherein the well maintenance tool is a sand bailing tool comprising an intake positioned below a reservoir and a float valve assembly positioned above the reservoir, wherein the intake comprises a check valve disposed between an open-mouthed inlet portion and the reservoir, wherein the inlet portion, check valve, and reservoir are all in fluid communication; the float valve assembly comprises a cylindrical valve assembly having openings at a top portion and a bottom portion and at least one fluid inlet disposed within a sidewall of the valve assembly; an exit cap attached to the top portion of the valve assembly, wherein the exit cap includes an exit opening surrounded by an embedded O-ring; a removable bottom cap attached to the bottom portion of the valve assembly; and a ball float disposed within the valve assembly, wherein the diameter of the ball float is less than an inner diameter of the valve assembly but greater than an inner diameter of the O-ring and of the fluid inlet; wherein the flexible hose is drained of fluid before the sand bailing tool is attached in step (e), the sand bailing tool is pressurized using an inert gas before lowering the tool in step (f), and wherein the sand bailing tool is operated in step (g) by lowering the sand bailing tool until it reaches the bottom of the well, at which point the pressure at the surface is relieved causing the check valve to open and forcing fluid and sand to be vacuumed into the reservoir until fluid begins exiting the reservoir thereby closing the float valve thereby entrapping the sand in the reservoir, raising the sand bailing tool out of the well, emptying the reservoir, and repeating as necessary to sufficiently remove sand from the well.

16. The method of claim 12, further comprising the step:
h) Lowering a fluid level meter into the well and accurately determining the current fluid level in the well.

17. A downhole well perforation cleaning tool configured to be attached to, and lowered by, a flexible hose, said tool comprising:
a pipe portion comprising a length disposed between a sealed cap at a distal end of the pipe and an attachment portion at a proximal end of the pipe, wherein the attachment portion is configured to be in fluid communication with the flexible hose; and
a plurality of cleaning devices disposed along the length of the pipe.

18. The tool of claim 17, wherein the plurality of cleaning devices comprise water jets, and wherein the tool further comprises a reservoir disposed between the proximal end of the pipe and the flexible hose.

19. The tool of claim 18, further comprising:
a plurality of rotator jets disposed along the length of the pipe positioned parallel to a vertical axis of the pipe; and
a rotary swivel disposed between the tool and the flexible hose.

20. The tool of claim 19, further comprising at least one cleaning brush extending outwardly from the length of the pipe.
